(19) United States
(12) Patent Application Publication
(10) Pub. No.: US 2005/0172773 A1
(43) Pub. Date: Aug. 11, 2005

(54) Rip guide adjusting device of circular saw

(75) Inventors: George Ku, Taichung Hsien (TW); Eric Lo, Taichung Hsien (TW)

Correspondence Address: BACON & THOMAS, PLLC, 625 SLATERS LANE, FOURTH FLOOR, ALEXANDRIA, VA, 22314, US

(73) Assignee: REXON INDUSTRIAL CORP., LTD., Taichung Hsien (TW)

(21) Appl. No.: 10/773,303

(22) Filed: Feb. 9, 2004

(51) Int. Cl. B23D 45/06

(52) U.S. Cl. 83/438; 83/477.2

(57) ABSTRACT

A circular saw includes a table with a blade rotatably connected thereto and a first rail and a second rail located on two sides of the table of the circular saw. A rip guide has a lock handle pivotably connected to a first end thereof and a guide piece is located at an underside of the lock handle. The guide piece has two rollers connected thereto which contact the upper surface of the first rail. A second end of the rip guide is slidably engaged with the second rail.

### FIELD OF THE INVENTION

The present invention relates to a rip guide adjusting device for a circular saw and the device includes rollers which assist movement of the rip guide on side rails of the circular saw.

### BACKGROUND OF THE INVENTION

A conventional circular saw 10 is disclosed in FIGS. 1 and 2, and generally includes a base 11 and a table 12 on the base 11. A blade 14 is rotatably extends through a slot defined through the table 12 and a rip guide 13 is movably connected to the table 12 so as to ensure a stable feed of the board to be cut. A rail 121 is connected to a side of the table 12 and includes scales marked thereon. The rip guide 13 includes a lock handle 131 on a first end thereof and a guide piece 132 which is located at an underside of the lock handle 131 and movably engaged with the rail 121. A window 15 is defined through the guide piece 132 so as to observe the scales on the rail 121. A hook portion 133 is connected to an underside of a second end of the rip guide 13 and engaged with a groove 122 defined in an underside of a side of the table 12. The lock handle 131 securely positions the rip guide at a desired position on the table 12 and can be lifted to unlock the positioning of the rail 121 so as to slide the rip guide 13 along the scaled rail 121. Nevertheless, when adjusting the position of the rip guide 13, the user has to push the rip guide 13 by hands so as to move the heavy rip guide 13 along the rail 121 and this is difficult to position the rip guide 13 at desired scale quickly. This is because there is no assistant device to move the rip guide 13 so that the user has to push the rip guide 13 from two ends simultaneously to move the rip guide 13.

The present invention intends to provide an adjusting device for easily move the rip guide of a circular saw.

### SUMMARY OF THE INVENTION

The present invention relates to a circular saw which comprises a base with a table on a top thereof and a blade rotatably extends through a slot defined in the table. A first rail and a second rail are located on two sides of the table. A rip guide has a lock handle pivotably connected to a first end thereof and a guide piece is located at an underside of the lock handle. The guide piece has two rollers connected thereto which contact an upper surface of the first rail. A second end of the rip guide is slidably engaged with the second rail.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional rip guide and a circular saw;

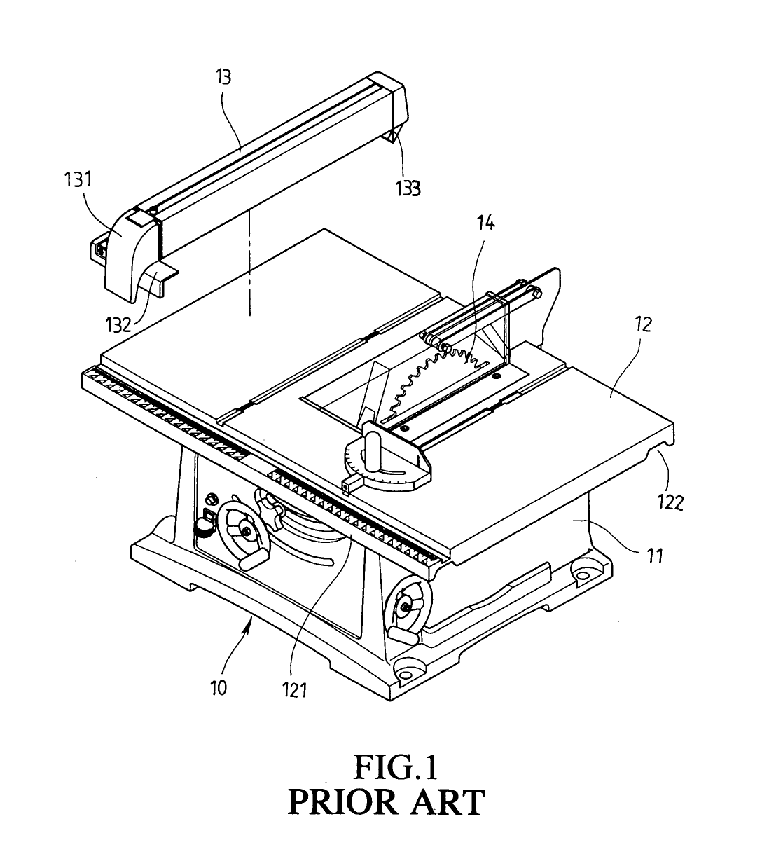

FIG. 2 shows that the guide piece of the conventional rip guide is engaged with the scaled rail;

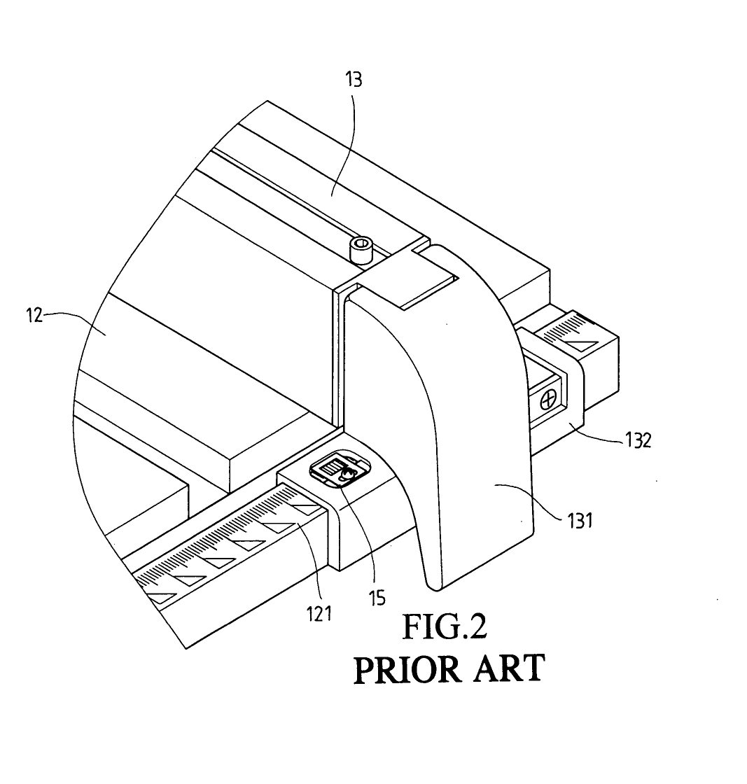

FIG. 3 shows the rip guide and the circular saw of the present invention;

FIG. 4 is an exploded view to show the rip guide of the present invention;

FIG. 5 is a cross sectional view to show the rollers of the rip guide contact the upper surface of the first rail of the circular saw of the present invention;

FIG. 6 is a cross sectional view to show an intermediate member of the rip guide contact the convex curve surface of the first rail of the circular saw of the present invention;

FIG. 7 is a cross sectional view to show the end member of the rip guide contact the second rail of the circular saw of the present invention, and

FIG. 8 is a top view to show the rip guide is moved by rolling the rollers.

### DETAILED DESCRIPTION OF THE PREFERRED EMBODIMENT

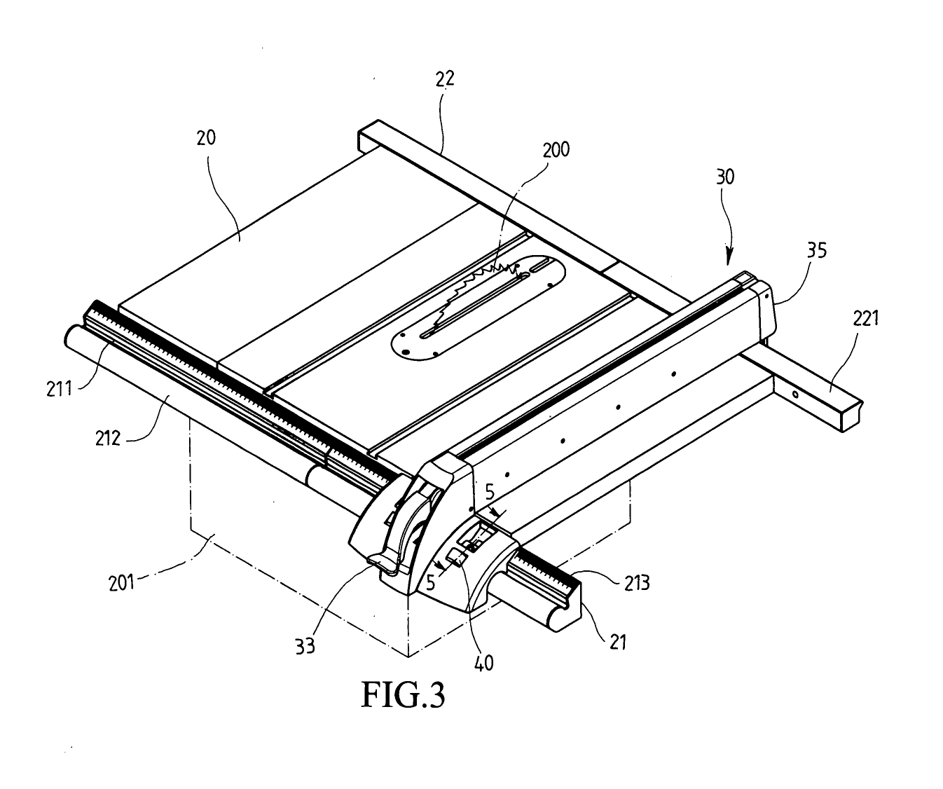

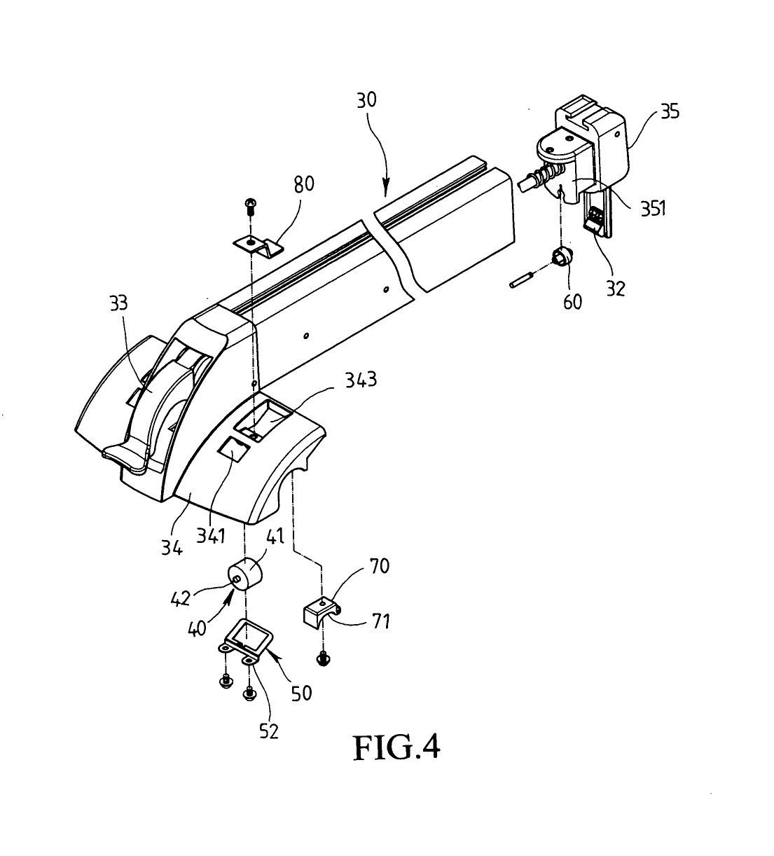

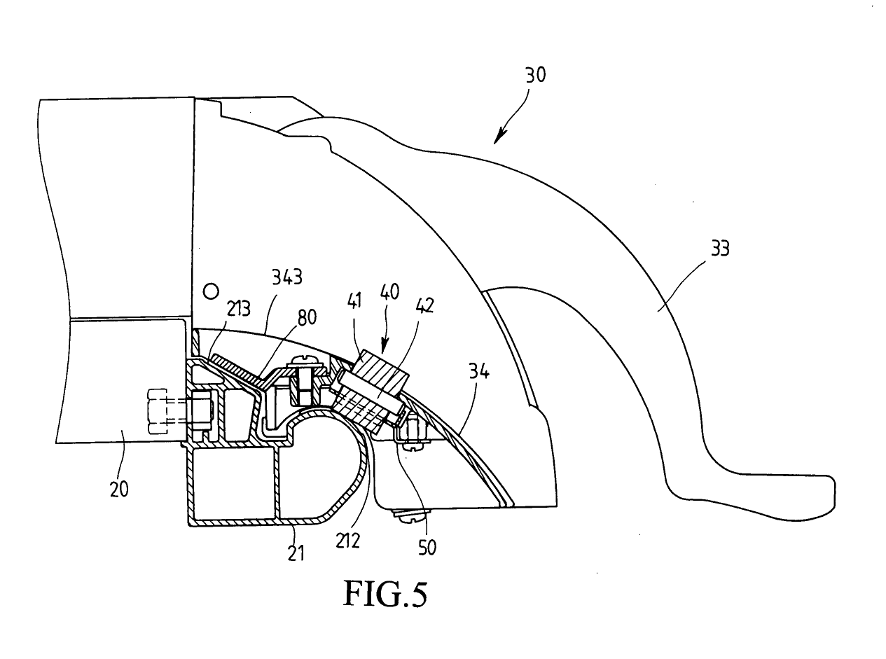

Referring to FIGS. 3 to 5, the circular saw of the present invention comprises a base 201 with a table 20 on a top of the base 201, and a blade 200 rotatably extends through a slot defined in the table 20. A first rail 21 with scales 213 and a second rail 22 are located on two sides of the table 20.

A rip guide 30 has a lock handle 33 pivotably connected to a first end thereof and a guide piece 34 is located at an underside of the lock handle 33. The guide piece 34 has two through holes 341 and each of the through holes 341 has one roller 40 engaged therewith. The two rollers 40 contact an upper surface of the first rail 21. Two windows 343 are defined through the guide piece 34 and each window 343 has a transparent plate 80 engaged therewith so as to easily observe the scales 213. A second end of the rip guide 30 has an end member 35 which is slidably engaged with the second rail 22. Each of the rollers 40 includes a rubber roller 41 and a shaft 42 extending through a center of the rubber roller 41. Each rubber roller 41 is enclosed by a rectangular retaining frame 50 which includes two lugs 52. Two bolts extend through the two lugs 52 and are connected to an underside of the guide piece 34. The rubber roller 41 is supported on the retaining frame 50 so that the rubber roller 41 is allowed to move downward slightly to contact the upper surface of the first rail 21 when the user pushes the rubber roller 41. The rubber roller 41 in each of the through holes 341 partially extends beyond a top surface of the guide piece 34 so that the user may roll the rubber roller 41 by hands.

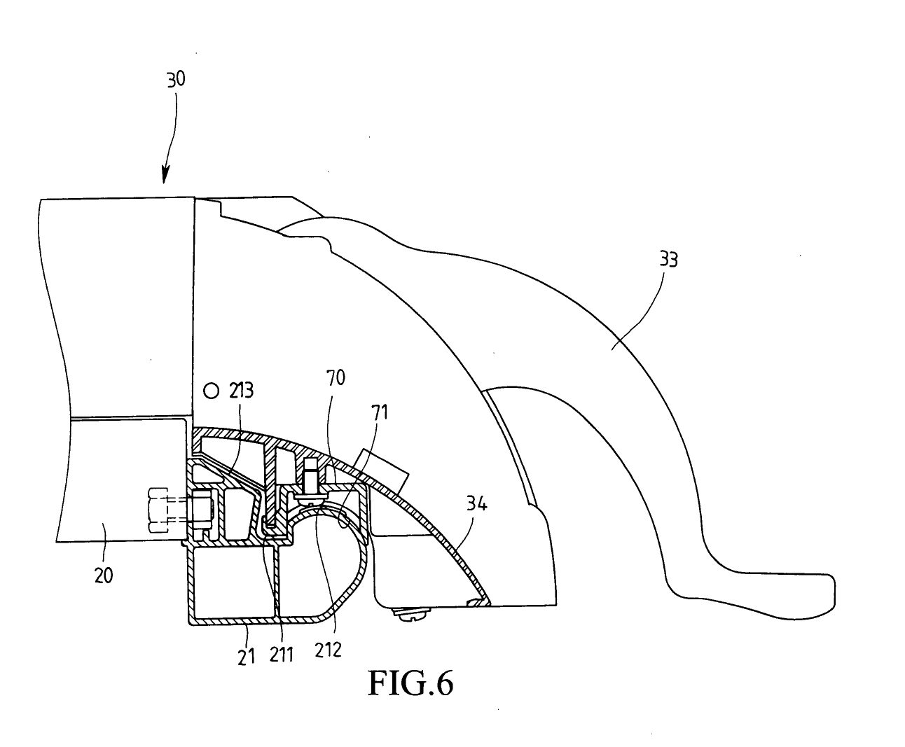

Further referring to FIG. 6, the first rail 21 includes a groove 211 defined longitudinally in the upper surface thereof which is an inclined surface such that the groove 211 is located between the scales 213 and a convex curve portion 212. An intermediate member 70 is connected between the rip guide 30 and the first rail 21, and has a protrusion which is slidably engaged with the groove 211 and a concave surface 71 which is matched with the convex curve portion 212.

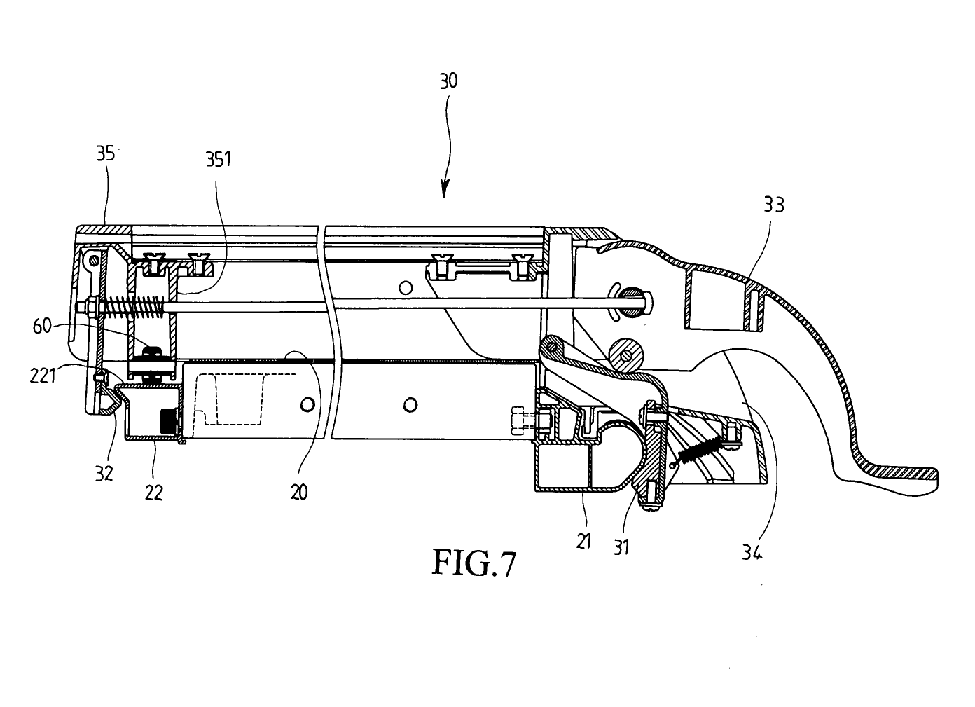

Further referring to FIG. 7, an end member 35 is connected to a second end of the rip guide 30 and includes an insertion 351 which is inserted in an opening of the second end of the rip guide 30. An assist roller 60 is connected to an underside of the insertion 351 and extends beyond an opening defined in an underside of the second end of the rip guide 30 so as to contact a top surface 221 of the second rail 22. A hooking member 32 is connected to the end member 35 and slidably engaged with an underside of a dovetail-shaped ridge projecting from the second rail 22.

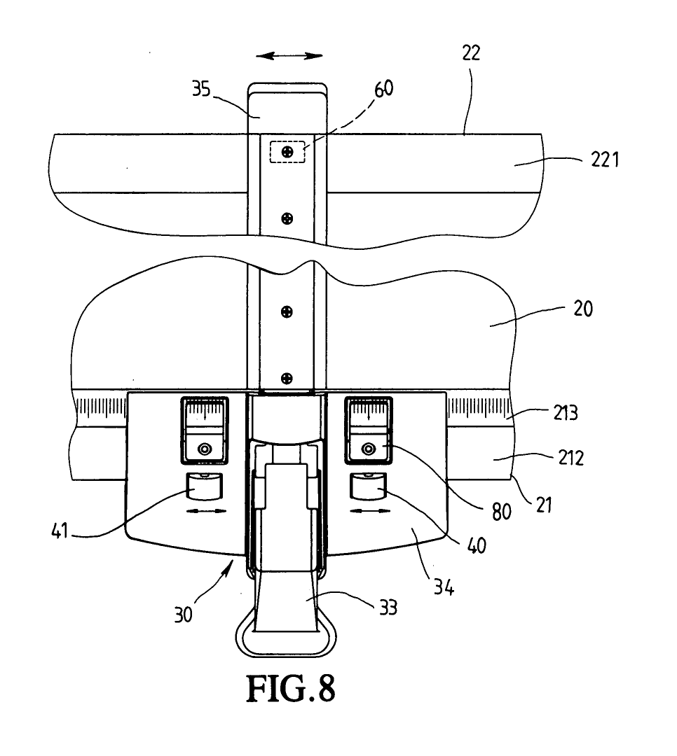

As shown in FIG. 8, when moving the rip guide 30, the lock handle 33 is pivoted upward and the user may roll the two rubber rollers 41 by hands to move the rip guide 30 which is easily moved by the two rollers 40 and the assist roller 60. The lock handle 33 is pivoted downward to lock the position when the rip guide 30 moves to the desired position.

While we have shown and described the embodiment in accordance with the present invention, it should be clear to those skilled in the art that further embodiments may be made without departing from the scope of the present invention.

1. A circular saw comprising:
a base with a table on a top of the base, a blade rotatably extending through a slot defined in the table, a first rail and a second rail located on two sides of the table, said first and second rails each having lower and upper surfaces, and
a rip guide having a lock handle pivotably connected to a first end thereof and a guide piece located at an underside of the lock handle, the guide piece having at least one roller connected thereto which contacts the upper surface of the first rail, a second end of the rip guide slidably engaged with the lower surface of the second rail.

2. The circular saw as claimed in claim 1, wherein the guide piece includes two through holes and each of the through holes has one roller engaged therewith.

3. A circular saw comprising:
a base with a table on a top of the base, a blade rotatably extending through a slot defined in the table, a first rail and a second rail located on two sides of the table, and
a rip guide having a lock handle pivotably connected to a first end thereof and a guide piece located at an underside of the lock handle, the guide piece having at least one roller connected thereto which contacts the upper surface of the first rail a second end of the rip guide slidably engaged with the lower surface of the second rail,
wherein a rectangular retaining frame is connected to the guide piece and located in each of the through holes, and the roller is rotatably enclosed by the retaining frame.

4. The circular saw as claimed in claim 2, wherein the roller in each of the through holes partially extends beyond a top surface of the guide piece.

5. The circular saw as claimed in claim 1, wherein the first rail includes a groove defined longitudinally in the upper surface thereof and the rip guide includes a protrusion which is slidably engaged with the groove.

6. The circular saw as claimed in claim 5, wherein the upper surface of the first rail includes a convex curve portion and an intermediate member is connected between the rip guide and the first rail, the intermediate member having the protrusion and a concave surface which is matched with the convex curve portion.

7. The circular saw as claimed in claim 1, wherein an end member is connected to a second end of the rip guide and includes an insertion which is inserted in an opening of the second end of the rip guide, an assist roller is connected to an underside of the insertion and extends beyond an opening defined in an underside of the second end of the rip guide, the assist roller contacts a top surface of the second rail, and a hooking member is connected to the end member and slidably engaged with an underside of a dovetail-shaped ridge projecting from the second rail.
